(19) United States
(12) Patent Application Publication
(10) Pub. No.: US 2009/0103133 A1
(43) Pub. Date: Apr. 23, 2009

(54) METHOD FOR PRODUCING PRINT PRODUCTS AND SYSTEM FOR ORDERING PRINT PRODUCTS

(75) Inventor: Thomas Reichhart, Aldenhoven (DE)

Correspondence Address: Ursula B. Day;Law firm of Ursula B. Day, Suite 1501, 708 Third Avenue, New York, NY, 10017, US

(73) Assignee: HIFLEX SOFTWARE GESMBH, Wien (AT)

(21) Appl. No.: 12/254,574

(22) Filed: Oct. 20, 2008

(30) Foreign Application Priority Data
Oct. 19, 2007 (DE) 10 2007 050 527.4

(51) Int. Cl. G06F 3/12

(52) U.S. Cl. 358/1.15

(57) ABSTRACT

A method for producing a print product is described where the product is defined by a master manuscript, ordered by an ordering system for print products and printed according to the print manuscript, in addition, an ordering system is described for print which includes a definition module for defining a product through a master manuscript, and includes a transmission module for transmitting to a vendor for print products and to facilitate the designation of a creator of the master manuscript as a recipient of a commission when the print is ordered through an ordering system on the internet, such that the ordering system initially reads an identification feature of the creator of the master manuscript from the master manuscript, and an order to produce the print product is associated with the creator, and the ordering system includes an identification module, by which a creator of the master manuscript can be identified, and an association module, by which the order can be associated with the creator.

### CROSS-REFERENCES TO RELATED APPLICATIONS

This application claims the priority of German Patent Application Serial No. 10 2007 050 527.4, filed Oct. 19, 2007 pursuant to 35 U.S.C. 119(a)-(d), the subject matter of which is incorporated herein by reference.

### BACKGROUND OF THE INVENTION

The invention, on the one hand, relates to a method for producing a print product, wherein the print product is defined based on a master manuscript, ordered through an ordering system for print products, and printed according to the master manuscript. On the other hand, the invention also relates to an ordering system for print products, comprising a definition module, by which a print product can be defined based on a master manuscript, and comprising a transmission module, by which an order for the print product can be transmitted to a vendor of the print products.

Such methods and ordering systems as described above are implemented e.g. in the portal www.printplaza.com of Print Plaza AG, Düsseldorf, Germany, and they are widely known and increasingly used as a front end by buyers for ordering of print products. Large graphic production facilities, which are vendors for individual print products, e.g., use advertising the statement that they offer several hundred thousand different print products for a buyer to choose from through their respective ordering system.

The master manuscript used in conjunction with such a method and respective ordering system is often not created by the buyer himself, but by a designer employed at the buyer, or more often, by a freelance design office working for the buyer as a service provider. For buyers, these service providers are preferred “natural” points of contact when looking for manufacturers for the print products, and for this reason, again from the point of view of the manufacturers of print products, they are important advertising vehicles for attracting new customers. In order to thus form an alliance with designers as advertising means, manufacturers offer them e.g. commissions for the referral of orders for the production of print products.

For example, a procedure is generally known, wherein the designer as a creator of a print product orders the print product at the manufacturer himself directly for the account of the buyer or for his own account, and receives a agreed upon commission from the manufacturer.

Since print products are increasingly ordered in an automated manner through ordering systems on the internet by the buyer himself, the creator of the master manuscript does not get into direct contact with the manufacturer anymore, is thus not identified as the creator of the master manuscript anymore, and is thus not determined as a recipient of a commission for the order that has been issued. Thus, the referral of such internet portals is not lucrative for the creator of the print product based on the known method.

It would therefore be desirable and advantageous to provide an improved method for producing a print product and a system for ordering print products to obviate such and other prior art shortcomings.

Thus, it is an object of the invention to facilitate the designation of the creator of a master manuscript as a recipient for a commission, when the print product is ordered through an ordering system on the internet.

### SUMMARY OF THE INVENTION

According to one aspect of the present invention, and based on the known method, it is proposed that an identifier of a creator of the print product is initially read by the ordering system from the master manuscript, and an order to produce the print product is associated with the creator. The creator of a master manuscript can tie such identifiers into the master manuscript in many ways, so that they neither impair their usability, nor are recognized at all by the user. In an automated ordering system, such identifier, however, can be read and used, so that the issued order is associated with the creator of the master manuscript, and the latter is designated as a recipient of a commission due to said association.

According to another aspect of the present invention a method for producing a print product includes defining the print product by a master manuscript, ordered by an ordering system for print products and printing according to the master manuscript, wherein the ordering system is initially reading an identifier of a creator of the master manuscript from the master manuscript, by the ordering system, and then associating an order to produce the print product with the creator.

The present invention resolves prior art problems by identifying a designer or creator of software, which is used for producing a master manuscript or both, the designer and creator, as creators of the master manuscript, who are entitled to a commission.

In an advantageous manner, the creator is identified by the ordering system through the method according to the invention based on a match with a definition of the identification feature in a creator dataset associated with the creator. Through the use of a database with service providers entitled to a commission as potential creators of master manuscripts, and by agreeing upon an individual identifier for each of the included service providers, the method according to the invention facilitates the automatic identification of the creator of a master manuscript and his designation as a recipient of a commission.

The master manuscript is provided preferably in PDF format for performing a method according to the invention. The use of PDF as a widely used format for producing these master manuscripts allows the creators of said master manuscripts to participate in the method according to the invention without substantial additional effort, in particular without purchasing manufacturer specific software for creating the print products.

Preferably, in the context of a method according to the invention, the identifier is a combination of ASCII characters. ASCII characters, thus substantially alphanumeric characters according to the American Standard Code for Information Interchange, can e.g. be simply provided as predefined fields in the header of a PDF file and can be read from said fields in an automated manner. Alternatively, the identifier can also be a graphically configured character, e.g. a bit map or a vector graphic, and can thus be integrated into the master manuscript. Also, a steganographic integration of the identifier into an image portion of the master manuscript is conceivable.

The identifier is advantageously not printed in the context of a method according to the invention. Thus, the identifier is not visible anymore in the finished print product. For example, the identifier can be integrated into the header as a graphic character outside of the printed paper format, or it can be integrated into the header as an ASCII character as described above. The identifier feature can also be disposed as a “transparent”, thus colorless and thus a non-printed character in the graphic portion of the master manuscript, or it can be automatically removed from the master manuscript after being detected. Alternatively, the identifier can also be integrated in the cutoff portion of the master manuscript, printed and subsequently removed by cutting the print product to size.

Based on the known ordering system, it is proposed according to the invention to provide an identification module, by which a creator of a master manuscript can be identified, and an association module, by which the order can be associated with the creator of the master manuscript. Such an ordering system facilitates the execution of a method according to the invention and comprises its advantages.

In a particularly preferred manner, an ordering system according to the invention comprises a registration module, by of which creator data can be registered in a creator dataset. In such an ordering system, a database with potential creators can be established. Alternatively, the registration module can also be implemented independent from the ordering system in the context of a method according to the invention, wherein the ordering system then interrogates the external database of the registration module.

In the creator database of such an ordering system according to the invention, preferably an identifier can be defined, and the creator can be identified by the identification module through detecting the identifier. The identification module of an ordering system according to the invention can look for these identifiers in the associated master manuscript, when an order is received, and can identify the creator of the master manuscript.

Furthermore, an ordering system according to the invention advantageously comprises a commission module, by which a commission for the order can be associated with the creator of the master manuscript. Such an ordering system according to the invention can then automatically initiate the payment of the commission to the creator in an accounting system connected therewith. Alternatively, also this commission module can be implemented outside of the ordering system in the context of the present invention, e.g. in a job costing module executed subsequent to the manufacture of the print product.

### DETAILED DESCRIPTION OF AN EXEMPLARY EMBODIMENT

The invention is subsequently described with reference to an embodiment. A manufacturer of print products, here a large printing company with a product portfolio of more than 250,000 different individual print products, provides this product offering in an ordering system according to the invention for buyers of print products, which is accessible for the public through the internet. The technical capabilities of the printing business comprise offset- and digital print in formats of 85×54 mm for business cards, up to large format prints of 100×220 cm on approximately twenty different types of papers with lamination, lacquering or glue coating or as a carbon copy set, wire- or thread stitched, ring- or glue bound in Leporello- or roll fold, or rolled up in standard- or express production and/or delivery.

In the ordering system according to the invention, the buyer at his PC workstation selects through the selection module opened in a standard browser initially a product type from a clearly laid out choice of only eleven standardized product types, thus the product types only comprised of a single sheet: “postcard”, “label”, “business card”, “folded flyer” and “unfolded flyer”, “stationery”, “poster”, and “XXL poster”, and the product types comprised of plural product components: “block”, “carbon copy set”, “folder”, “glue bound brochure”, “wire bound brochure”, and “ring bound brochure”. The buyer selects there from a Leporello folded flyer in the final format C6 long.

In the article database, widely used print runs are defined for each of the standardized product types. After completion of the definition of the print product, the ordering system determines the respective cost portions for these predefined print runs, based on the values and the cost factors of the selected articles, and from that, as a sum, the cost of the print product, and displays the respective prices, sorted according to increased print run to the buyer in the selection module. After the selection of a print run of 15,000 pieces, the ordering system displays a page with a short description of the selected article to the buyer, wherein said page includes further options. In particular, various options for proofs for shipping and for the print data format are offered.

The buyer selects the portable document format from various formats of print data accepted in the ordering system and transmits a PDF file, which resides on its local hard drive, upon request by the ordering system. After the entry of the identification of the buyer, the ordering system confirms the receipt of the order on a separate screen page and by e-mail and transmits the order to produce the flyer to the large print shop. An identification module of the ordering system analyzes the transmitted master manuscript, so this is not evident to the buyer, and finds a manually inserted comment line “% ppID0815”in the header of the file. The identification module subsequently searches the database of the ordering system for a creator dataset with the identification feature “0815” and transmits a referral to the creator dataset found and transmits a referral to the order to an association and commission module of the ordering system.

The association and commission module associates the order according to the creator dataset with a “Professional Design AG, Bern/CH” as the creator of the master manuscript, determines the amount of commission from a commission percentage stored in the creator database and from the volume of the order, and initiates the transfer of the commission through an accounting module to an account of the creator, which is also defined in the creator dataset.

An employee of the creator had registered said creator dataset at his PC workstation in the registration module of the ordering system, which had been opened in a standard browser, and had thus defined the data of the creator dataset. The ordering system provides a browser executable script to registered creator through a personal page, wherein said script automatically inserts the above mentioned comment line into a PDF file to be selected.

While the invention has been illustrated and described as embodied in an ordering system according to the invention, it is not intended to be limited to the details shown since various modifications and structural changes may be made without departing in any way from the spirit of the present invention. The embodiment was chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

1. A method for producing a print product, comprising the steps of:
defining the print product by a master manuscript, ordered by an ordering system for print products and printing according to the master manuscript, wherein the ordering system is initially reading an identifier of a creator of the master manuscript from the master manuscript, by the ordering system, and then
associating an order to produce the print product with the creator.

2. The method according to claim 1, further comprising the step of identifying the creator by the ordering system based on a match with a definition of an identification feature in a creator dataset associated with the creator.

3. The method according to claim 1, wherein the master manuscript is provided in portable document format.

4. The method according to claim 2, wherein the identification feature is a combination of ASCII characters.

5. The method according to claim 2, wherein the identification feature is not printed.

6. An ordering system for print products comprising:
a definition module for defining a print product based on a master manuscript, and a transmission module for transmitting an order for the print product to a vendor of print products, and wherein the system includes an identification module for identifying a creator of the master manuscript and an association module for associating the order with the creator.

7. The ordering system according to claim 6, further comprising a registration module for registering data of the creator in a creator dataset.

8. The ordering system according to claim 7, wherein the creator dataset includes a definable identification feature and the creator is identifiable by the identification module through recognition of the identification feature.

9. The ordering system according to claim 5, further comprising a commission module, by which a commission for the order is associated with the creator.
